(19) United States
(12) Patent Application Publication
(10) Pub. No.: US 2018/0367319 A1
(43) Pub. Date: Dec. 20, 2018

(54) SECURE POWER OVER ETHERNET POWER DISTRIBUTION SYSTEM

(71) Applicant: Dell Products L.P., Round Rock, TX (US)

(72) Inventors: Rabah S. Hamdi, Jonestown, TX (US); Srinivasa Rao Nagalla, Round Rock, TX (US)

(21) Appl. No.: 15/623,706

(22) Filed: Jun. 15, 2017

(51) Int. Cl. H04L 12/10; G06F 1/26; G06F 1/32

(52) U.S. Cl. CPC H04L 12/10; G06F 1/3209; G06F 1/266

(57) ABSTRACT

A power over Ethernet (PoE) system includes a device and a power sourcing equipment (PSE) device that is configured to couple to the device through an Ethernet cable. The PSE device detects, in response to the device being coupled to the PSE device, that the device is a powered device. Subsequent to detecting that the device is a powered device, the PSE device determines whether a powered device identifier has been received from the device. In response to determining that a powered device identifier was received from the device, the PSE device determines that the powered device identifier identifies an authorized powered device. The PSE device then identifies a powered device classification of the powered device, and provides to the device via the Ethernet cable, first power according to the powered device classification.

### BACKGROUND

The present disclosure relates generally to information handling systems, and more particularly to efficiently and securely powering information handling systems using Power over Ethernet.

As the value and use of information continues to increase, individuals and businesses seek additional ways to process and store information. One option available to users is information handling systems. An information handling system generally processes, compiles, stores, and/or communicates information or data for business, personal, or other purposes thereby allowing users to take advantage of the value of the information. Because technology and information handling needs and requirements vary between different users or applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use such as financial transaction processing, airline reservations, enterprise data storage, or global communications. In addition, information handling systems may include a variety of hardware and software components that may be configured to process, store, and communicate information and may include one or more computer systems, data storage systems, and networking systems.

Some IHSs use Power over Ethernet (PoE) technology to send and/or receive power and data with other IHSs. PoE technology provides for the safe transmission of power, along with the data, over Ethernet cabling. The original Institute of Electrical and Electronics Engineers (IEEE) 802.3af standards provide up to 15.4 watts (W) of DC power (minimum 44 volts (V) direct current (DC) and 350 milliamps (mA)), while the updated IEEE 802.3at standards (also known as PoE+) provides up to 25.5 W. The IEEE 802.3af and IEEE 802.3at standards provide for detection of powered devices (PDs) based on a presence of a 23.75 KΩ-26.25 KΩ resistor, as well as the classification of the powered devices based on a predefined control protocol or hardware classification, and the power sourcing equipment (PSE) device may then statically assign the power level of the power that will be provided to the powered device based on the amount of power designated in the standards for the powered device's classification.

Thus, PoE technology detects whether a device connected to the PSE device is a powered device or not, and then automatically provides power based on the classification of the powered device. However, in some situations, certain powered devices should not be connected to a PSE device, and conventional PoE provides no validation process in response to the connection of a powered device to the PSE device. As such, powered devices may be connected to, and draw power from, the PSE device when they are not authorized to do so, which may require an administrator to physically track powered devices connected to the PSE device to determine which ones are authorized and which ones are unauthorized. Furthermore, unauthorized powered devices that draw power from the PSE device waste valuable power that may be used to power authorized powered devices.

Accordingly, it would be desirable to provide an improved secure Power over Ethernet (PoE) power distribution system.

### SUMMARY

According to one embodiment, a power sourcing equipment (PSE) device, includes a power over Ethernet (PoE) interface; a processing system coupled to the PoE interface; and a memory system coupled to the processing system and including instructions that, when executed by the processing system, cause the processing system to: detect, in response to a device being coupled to the PSE device through the PoE interface, that the device is a powered device; determine, subsequent to detecting that the device is a powered device, whether a powered device identifier has been received from the device; determine, in response to determining that a powered device identifier was received from the device, that the powered device identifier identifies an authorized powered device; identify, in response to determining that the powered device identifier identifies is an authorized powered device, a powered device classification of the powered device; and provide, to the device via the PoE interface, first power according to the powered device classification.

### BRIEF DESCRIPTION OF THE DRAWINGS

FIG. 1 is a schematic view illustrating an embodiment of an information handling system (IHS).

FIG. 2 is a schematic view illustrating an embodiment of a power over Ethernet (PoE) system.

FIG. 3 is a schematic view illustrating an embodiment of a power sourcing equipment (PSE) device included in the PoE system of FIG. 2.

FIG. 4 is a schematic view illustrating an embodiment of a powered device included in the PoE system of FIG. 2.

FIG. 5 is a flow chart illustrating an embodiment of a method for securely providing PoE power.

FIG. 6 is a screen shot illustrating an embodiment of a graphical user interface used to configure unauthorized powered devices connected to the PSE device during the method of FIG. 5.

### DETAILED DESCRIPTION

For purposes of this disclosure, an information handling system may include any instrumentality or aggregate of instrumentalities operable to compute, calculate, determine, classify, process, transmit, receive, retrieve, originate, switch, store, display, communicate, manifest, detect, record, reproduce, handle, or utilize any form of information, intelligence, or data for business, scientific, control, or other purposes. For example, an information handling system may be a personal computer (e.g., desktop or laptop), tablet computer, mobile device (e.g., personal digital assistant (PDA) or smart phone), server (e.g., blade server or rack server), a network storage device, or any other suitable device and may vary in size, shape, performance, functionality, and price. The information handling system may include random access memory (RAM), one or more processing resources such as a central processing unit (CPU) or hardware or software control logic, ROM, and/or other types of nonvolatile memory. Additional components of the information handling system may include one or more disk drives, one or more network ports for communicating with external devices as well as various input and output (I/O) devices, such as a keyboard, a mouse, touchscreen and/or a video display. The information handling system may also include one or more buses operable to transmit communications between the various hardware components.

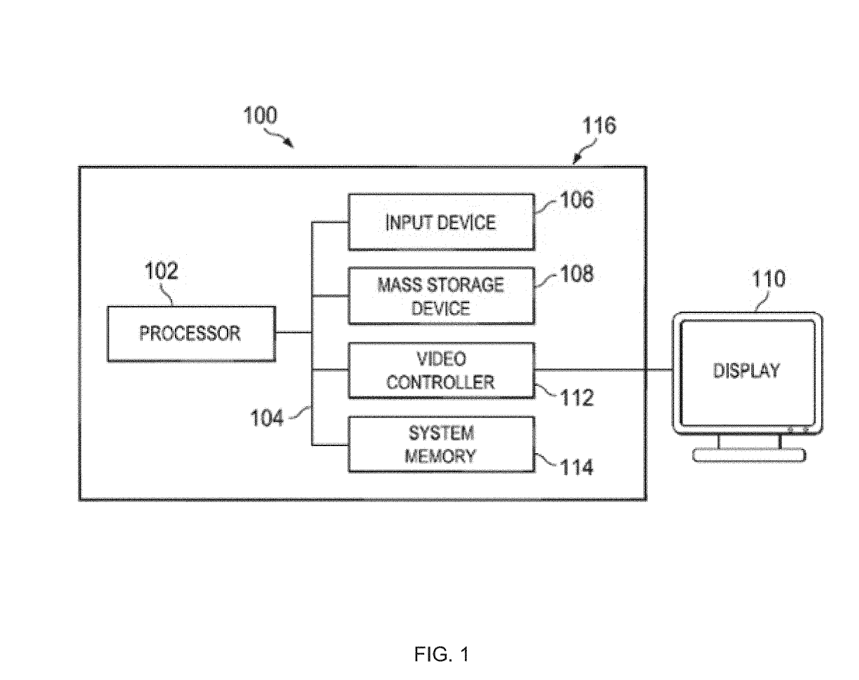

In one embodiment, IHS 100, FIG. 1, includes a processor 102, which is connected to a bus 104. Bus 104 serves as a connection between processor 102 and other components of IHS 100. An input device 106 is coupled to processor 102 to provide input to processor 102. Examples of input devices may include keyboards, touchscreens, pointing devices such as mouses, trackballs, and trackpads, and/or a variety of other input devices known in the art. Programs and data are stored on a mass storage device 108, which is coupled to processor 102. Examples of mass storage devices may include hard discs, optical disks, magneto-optical discs, solid-state storage devices, and/or a variety other mass storage devices known in the art. IHS 100 further includes a display 110, which is coupled to processor 102 by a video controller 112. A system memory 114 is coupled to processor 102 to provide the processor with fast storage to facilitate execution of computer programs by processor 102. Examples of system memory may include random access memory (RAM) devices such as dynamic RAM (DRAM), synchronous DRAM (SDRAM), solid state memory devices, and/or a variety of other memory devices known in the art. In an embodiment, a chassis 116 houses some or all of the components of IHS 100. It should be understood that other buses and intermediate circuits can be deployed between the components described above and processor 102 to facilitate interconnection between the components and the processor 102.

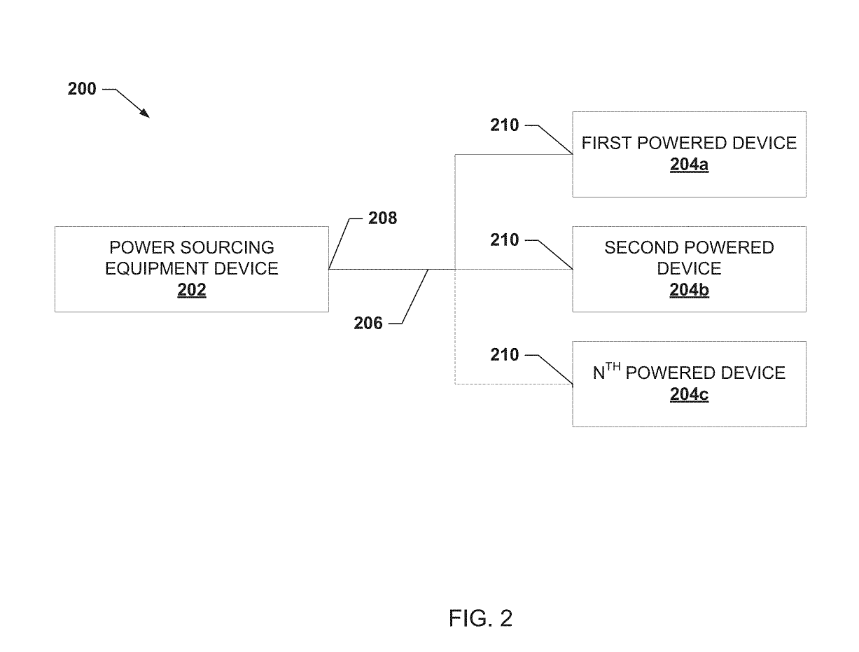

Referring now to FIG. 2, an embodiment of a power over Ethernet (PoE) system 200 is illustrated. The PoE system 200 includes a power sourcing equipment (PSE) device 202 coupled to a plurality of powered devices (PDs), such as a first powered device 204a, a second powered device 204b, and up to an N^{TH} powered device 204c of the illustrated embodiment. In an embodiment, any of the PSE device 202, the first powered device 204a, the second powered device 204b, and up to the N^{TH} powered device 204c may be the IHS 100 and/or include some or all of the IHS components of the IHS 100, discussed above with reference to FIG. 1. For example, the PSE device 202 may be a switch, a bridge, and/or a variety of other network IHSs known in the art. In another example, the powered devices 204a, 204b, and 204c may be network access points (e.g., wireless access points), IP telephony devices, monitoring devices (e.g., camera systems), point of sale devices, and/or a variety of other powered devices known in the art. As discussed in more detail below, the PSE device 202 may include a processor and a memory that includes instructions that, when executed by the processor, cause the processor to provide power and data to the powered devices 204a, 204b, and 204c, determine the actual power consumption of the powered devices 204a, 204b, and 204c, communicate with the powered devices 204a, 204b, and 204c, and provide any of the other PSE device functions discussed below. As also discussed below, any of the powered devices 204a, 204b, and/or 204c may include a processor and a memory that includes instructions that, when executed by the processor, cause the processor to determine the power requirements of the powered device, communicate with the PSE device 202, and provide any of the other powered device functions discussed below.

The PSE device 202 may be coupled to each of the first powered device 204a, the second powered device 204b, and the N^{TH} powered device 204c through one or more cables 206 (e.g., an Ethernet cable) that couple to the PSE device 202 through one or more interfaces 208 (e.g., PoE interfaces), and that couple to the powered devices 204a, 204b, and 204c through interfaces 210 (e.g., PoE interfaces). While not illustrated, one of skill in the art will recognize that the PSE device 202 may be coupled to a network (e.g., the Internet), a data source (e.g., a server), as well as a power source (e.g., an Alternating Current (AC) power source), and thus may include components for providing data from the network or data source and providing power from the power source safely via the interface 208 and through the cable(s) 206, as discussed in further detail below. Similarly, while not illustrated, one of skill in the art will recognize that the powered devices 204a, 204b, and 204c may include components for extracting data and power sent over the cable(s) 206 from the PSE device 202 and received through the interfaces 210, as discussed in further detail below.

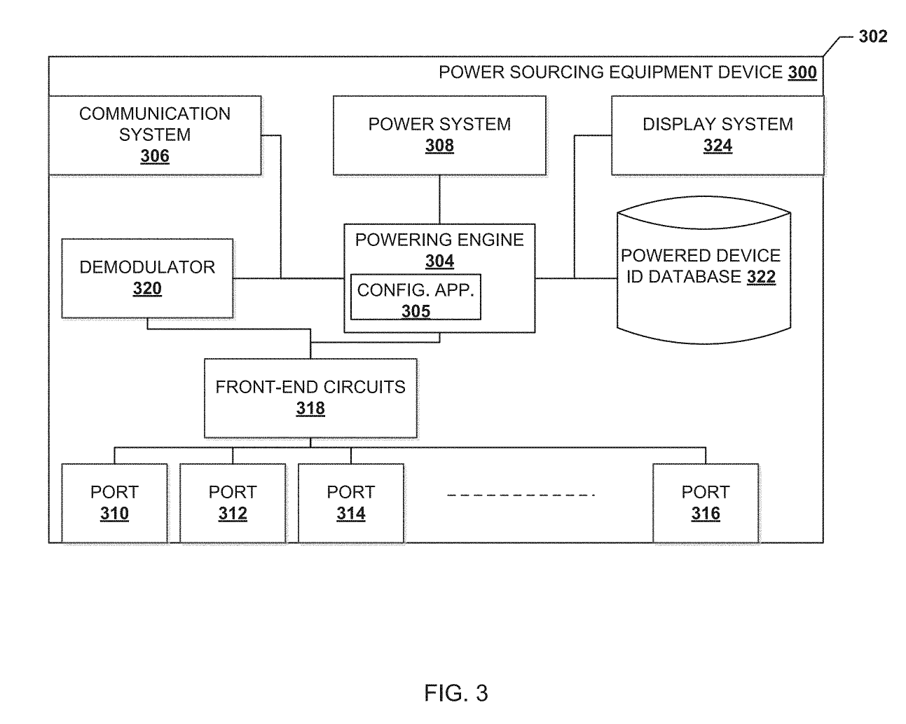

Referring now to FIG. 3, an embodiment of a PSE device 300 is illustrated. In an embodiment, the PSE device 300 may be the PSE device 202 discussed above in the PoE system 200 of FIG. 2. As such, the PSE device 202 may be the IHS 100 discussed above with reference to FIG. 1 and/or may include some or all of the components of the IHS 100, and in the specific embodiments discussed below may be provided as a switch, router, or other networking device known in the art. However, in other embodiments, the PSE device 300 may be any computing device that is configured to provide power and data to a powered device (e.g., via the PoE standard through an Ethernet port and over an Ethernet cable), as discussed in further detail below. The PSE device 300 includes a chassis 302 that houses a processing system (not illustrated, but which may include one or more of the processor 102 discussed above with reference to FIG. 1) and a memory system (not illustrated, but which may include system memory 114 discussed above with reference to FIG. 1) that includes instructions that, when executed by the processing system, cause the processing system to provide the powering engine 304 that is configured to perform the functions of the powering engines and/or PSE devices discussed below.

In the illustrated embodiment, the powering engine 304 includes powering sub-engines such as a powered device configuration application 305. As discussed below, in some embodiments, the powered device configuration application 305 is configured to provide a user interface through a display system 324 that is housed in the chassis 302, that may be coupled to the powering engine 304 (e.g., via a coupling between the display system 324 and the processing system), and that is configured to display information discussed below via the user interface. While the display system 324 is illustrated as housed in the chassis 302, one skilled in the art will recognize that the display system 324 may be housed in a chassis of another computing device that is in communication with the powering engine 304 through, for example, a communication system 306 that is housed in the chassis 302, that is coupled to the powering engine 304 (e.g., via a coupling between the communication system 306 and the processing system), and that may include a Network Interface Controller (NIC), a wireless communication system (e.g., a BLUETOOTH® communication system, an NFC communication system, etc.), and/or other communication components that enable the communication discussed below.

A power system 308 is included in the chassis 302 and coupled to the powering engine 304 (e.g., by a coupling between the processing system and the power system 308). In an embodiment, the power system 308 may include a power supply unit, a power adapter, and/or a variety of other power system subsystems known in the art that are configured to receive power from a power source (e.g., and Alternating Current (AC) power source) and provide that power to components in the PSE device 300. A plurality of ports 310, 312, 314, and up to 316 are coupled to the powering engine 304 (e.g., via a coupling between the processing system and the ports) and located on the chassis 302 such that they are accessible on the outer surface of the PSE device 300. The one or more of the ports 310-316 may be included in the interface 208 of FIG. 2. In an embodiment, the coupling between the processing system and the ports 310-316 may be provided via front-end circuits 318 that may include, for example, an analog front-end (AFE) configured to filter analog/digital signals and convert analog signals to digital signals and vice versa. In the embodiments discussed below, the ports 310-316 are Ethernet ports (e.g., RJ-45 connectors), but in other embodiments may include other ports known in the art. In a specific example, the PSE device 300 is a PoE device that is configured to provide power received by the power system 308 to one or more of the ports 310-316, and one or more ports 310-316 are configured to transmit that power, along with data, over Ethernet cables (that are coupled to those ports). The chassis 302 may also house a demodulator 320 that is coupled to the front-end circuits 318 and the power engine 304 and that is configured to demodulate a modulated signal received through any of the ports 310-316, as well as perform any of the other functionality discussed below.

The chassis 302 may also house a storage system (not illustrated, but which may include the storage device 108 discussed above with reference to FIG. 1) that is coupled to the powering engine 304 (e.g., via a coupling between the storage system and the processing system) and that includes a powered device (PD) identifier database 322 that is configured to store the data that enables the functionality discussed below. While a specific embodiment of a PSE device 300 has been described, one of skill in the art in possession of the present disclosure will recognize that PSE devices may be provided with a variety of other components that provide for conventional PSE device functionality, as well as the functionality discussed below, while remaining within the scope of the present disclosure.

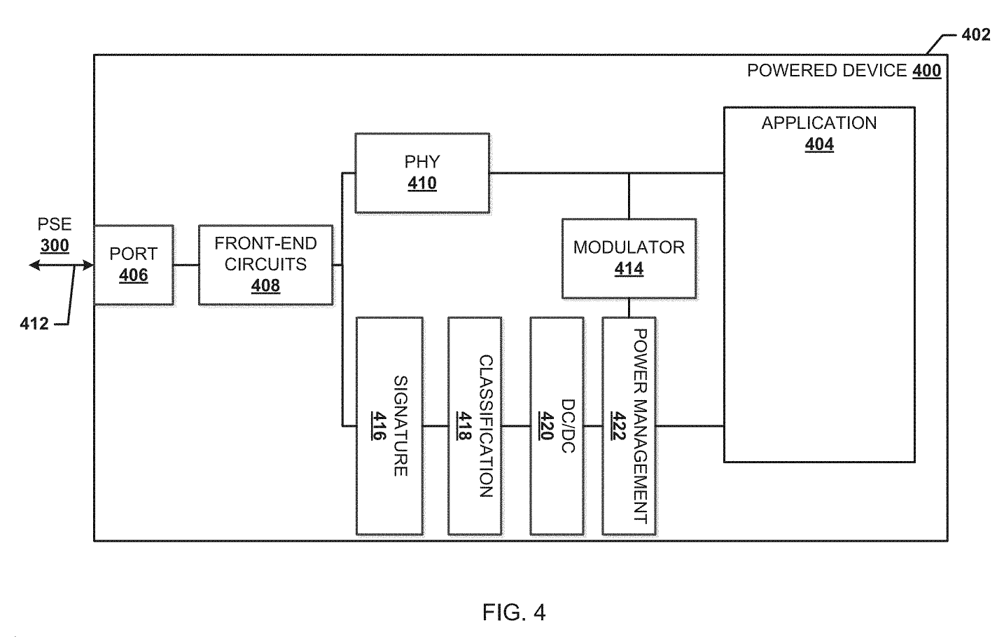

Referring now to FIG. 4, an embodiment of a powered device (PD) 400 is illustrated. In an embodiment, the powered device 400 may be any of the powered devices 204a-204c discussed above in the PoE system 200 of FIG. 2. As such, the powered device 400 may be the IHS 100 discussed above with reference to FIG. 1 and/or may include some or all of the components of the IHS 100, and in the specific embodiments discussed below, may be provided as internet protocol (IP) phones, wireless local area network (LAN) access points, security network cameras, or other Ethernet terminals known in the art. However, in other embodiments, the powered device 400 may be any computing device that is configured to receive power from a PSE device (e.g., via the PoE standard through an Ethernet port and over an Ethernet cable), as discussed in further detail below. The powered device 400 includes a chassis 402 that may house PD application hardware 404 that may include a processing system (not illustrated, but which may include one or more of the processor 102 discussed above with reference to FIG. 1), an application specific integrated circuit (ASIC), a logic device, a memory system (not illustrated, but which may include system memory 114 discussed above with reference to FIG. 1) and/or other PD application hardware 404 that is configured to perform the functions of the powered device 400.

The PD application hardware 404 may be coupled to a port 406 (e.g., via a coupling between the processing system and the ports) that is located on the chassis 402 such that it is accessible on the outer surface of the powered device 400. In the embodiments discussed below, the port 406 is an Ethernet port (e.g., an RJ-45 connector), but in other embodiments may include other ports known in the art. The port 406 of the powered device 400 may couple to the PSE device 300 via a cable 412 that is configured to provide power and data from the PSE device 300 to the powered device 400. In a specific example, the powered device 400 is a PoE device that is configured to receive power and data over an Ethernet cable coupled to the port 406 from the PSE device 300. In an embodiment, the coupling between the PD application hardware 404 and the port 406 may be through front-end circuits 408 that may include, for example, an analog front-end for filtering analog signals and converting analog and digital signals to digital and analog signals, respectively. The coupling may include a data path from the front-end circuits 408, through a physical layer chip (PHY) 410 (e.g., and Ethernet PHY), and to the PD application hardware 404 to receive and provide network data signals.

The coupling between the PD application hardware 404 and the front-end circuits 408 may include a power path for the PD application hardware 404 to receive power from the port 406. In an embodiment, the power path may include a signature circuit 416 coupled to the port 406. The signature circuit 416 may include a resistor (e.g., a 23.75 KΩ-26.25 KΩ resistor). The power path may also include a classification circuit 416 that is coupled to the port 406 and that is configured to provide a current through the port 406 in response to receiving probing voltages from the PSE device 300. The power path may also include a DC/DC converter 420 that is coupled to the port 406 and that is configured to convert a voltage received from the PSE device 300 to an operational voltage that may be used to operate the PD application hardware 404. In an embodiment, the powered device 400 may also include a power management circuit that is used to distribute the power received from the PSE device 300 between the PD application hardware 404 and other components of the powered device 400.

In an embodiment, the powered device 400 also includes a modulator 414 that is coupled to the data path and the power path discussed above. The modulator 414 may be configured to provide a modulated signal through the port 406, as well as provide any of the other functionality discussed below. The modulator 414 may also be configured to store a PD identifier that may include a device serial number, a product identifier, a product manufacturer identifier, a vender identifier, and/or any other PD identifier that would be apparent to one of skill in the art in possession of the present disclosure. The modulator 414 may also be configured to receive power from the port 406 through the power path in order to enable it to provide the modulated signal through the data path without the PD application hardware 404 receiving operational power.

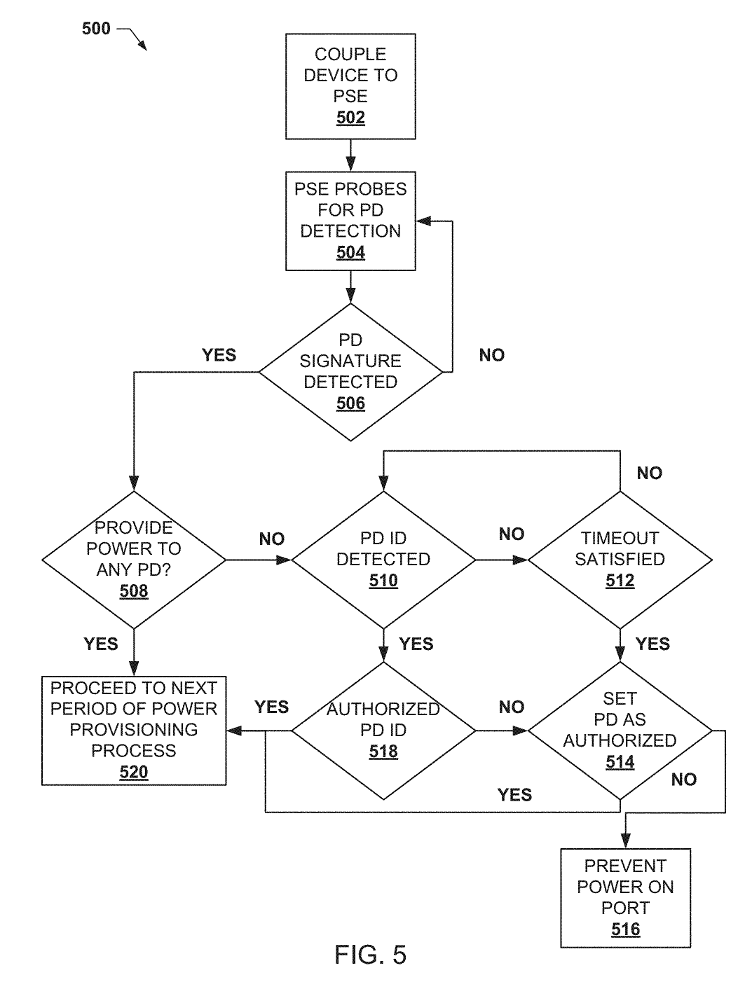

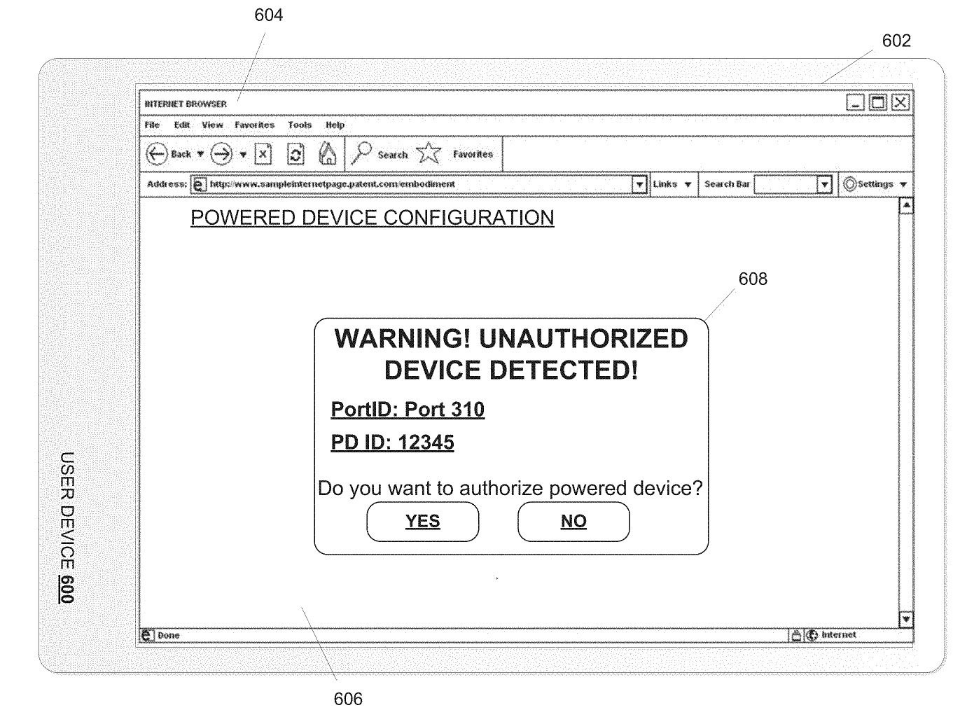

Referring now to FIG. 5, an embodiment of a method 500 of powering a powered device (PD) is illustrated. As discussed below, the method 500 provides a power sourcing equipment (PSE) device that can authorize a powered device during a power provisioning process that is configured provide operational power to authorized powered device. After detecting that a device that has been coupled to the PSE device is a powered device, the PSE device may probe the powered device with a voltage that provides enough power to the powered device to provide a PD identifier to the PSE device. The PSE device may then compare the PD identifier with PD identifiers that are stored in a PD identifier database of authorized powered devices in order to determine whether the PD identifier matches any of the stored PD identifiers associated with authorized powered devices. If the PSE device determines that the powered device is an authorized powered device (e.g., based on a match of the PD identifier and at least one of the stored PD identifiers), then the PSE may continue with various steps of the power provisioning process such as, for example, classification and power provisioning according to that classification. However, if the PSE device determines that the powered device is not an authorized powered device, then the PSE device may prevent power from being provided from the port of the PSE device that is coupled to the unauthorized powered device, thereby ending the power provisioning process. Alternatively, in response to determining that the powered device is not an authorized powered device, the PSE device may provide an unauthorized device notification to an administrator, and provide an option to the administrator to configure the PSE device to recognize the powered device as an authorized device. Thus, the PSE device is configured to provide an efficient, secure, and configurable method of delivering power (e.g., via Power over Ethernet) network that determines whether to deliver that power before operational power is provided to a powered device, minimizing the amount of tracking that an administrator has to perform in determining which powered devices connected to the PSE device are authorized or unauthorized, and reducing wasted power resources in provisioning and powering unauthorized powered devices.

The method 500 begins at block 502 where a device is coupled to a PSE device. In an embodiment, the first powered device 204a of FIG. 2 is connected to the PSE device 202 via a cable 206 (e.g., an Ethernet cable) that is connected to the interface 208 on the PSE device 202 and the interface 210 on the powered device 204a. While the method 500 references the PSE device 202 and the first powered device 204, the method 500 may be performed between any or all of the powered devices 204a, 204b, and 204c and the PSE device (and between multiple powered devices and a PSE device), as well as between the PSE device 202 and any other device, while remaining within the scope of the present disclosure. As would be understood by one of skill in the art in possession of the present disclosure, in some embodiments the device may be a device that is not configured to receive power and data via a coupling between the device and the PSE device 202, and thus may not be considered a powered device.

The method 500 then proceeds to block 504 where the PSE device probes at least one of its ports to detect a powered device coupled to an interface of the PSE device. In an embodiment, the PSE device 202 may begin a power provisioning process by entering a powered device detection period. During the powered device detection period, the PSE device 202 may probe the interface 208 of the PSE device 202 to determine whether any of the ports 310-316 of FIG. 3 are coupled to a PD device. For example, the PSE device 202 may probe the ports 310-316 by providing a probing signal to each of the ports 310-316 at power level that is less than a power level the PSE device 202 provides to any of the ports 310-316 when providing operational power to the first powered device 204a through that/those ports. For example, the PSE device 202 may provide a current or a voltage (e.g., between 10 Vdc and 2.8 Vdc) at block 504. However, one skilled in the art will recognize that other voltages less than or greater than that range will fall within the scope of the present disclosure as well. In a specific example, the powered device detection period may last up to 500 ms.

The method 500 then proceeds to block 506 where the PSE device determines whether the device coupled to the PSE device is a powered device. In an embodiment, in response to the PSE device 202 providing the probing signals to each port 310-316 at block 504, the PSE device 202 may receive a response signal that may include a powered device signature (e.g., a current measurement) sent by the device (e.g., the first powered device 204a). For example, the probing signals may provide a voltage to the device to determine whether a resistor is present, and the response signal provided back to the PSE device 202 may include a current measurement that the PSE device 202 is configured to use to determine whether that resistor exists. In an embodiment, the first powered device 204a may include the resistor that is included in the signature circuit 416. The first powered device 204a may receive the probing signal over the cable 412 and through the port 406, and that probing signal may then be provided through the front-end circuits 408 to the signature circuit 416. In response to receiving the providing signal, the signature circuit may then generate the response signal, and the port 406 may provide that response signal back through cable 412 to the PSE device 202. in an embodiment, the response signal may include the current measurement that the powering engine 304 of PSE device 202 may use to determine whether the resistor is a 25 KΩ resistor, which one of skill in the art in possession of the present disclosure will recognize may provide a powered device signature that indicates that the device connected to the PSE device 202 is a powered device. However, the resistor may be other resistor values (e.g., 23.75 KΩ-26.25 KΩ) according to the IEEE 802.3af and IEEE 802.3at standards, and the PSE device 202 may be configured to accept a range of 19 KΩ-26.5 KΩ resistor values and associated response signals when determining that a device is a powered device. If the PSE device 202 determines that the device is not a powered device (e.g., in response to a lack of detection of a PD signature (i.e., a response signal associated with detected resistor that is in the accepted range), the method 500 returns to block 504 where the PSE device 202 continues probing its ports 310-316 for powered devices.

If the PSE device 202 determines that the device is a powered device in response to detecting a PD signature, the method 500 proceeds to block 508 where the PSE device may determine whether it is configured to provide power to any powered device. In an embodiment, the PSE device 202 may include configuration instructions (e.g., stored in the PD identifier database 322) that may cause the powering engine 304 to allow any powered device connected to the PSE device 202 to receive power from the PSE device 202, or to only allow power to be provided from the PSE device 202 to authorized powered devices. If the powering engine 304 determines that the PSE device 202 is configured to provide power to any powered device, then the method 500 proceeds to block 520 where a classification period of the power provisioning process is optionally performed as discussed below.

If the PSE device 202 determines at block 508 that it is configured to only provide power to authorized powered devices, then the method proceeds to block 510 where the PSE device determines whether the device (which has been determined to be a powered device) includes a powered device (PD) identifier. In an embodiment, the PSE device 202 may determine whether the first powered device 204a includes a PD identifier. For example, the first powered device 204a may store a PD identifier (e.g., a device serial number, a product identifier, a product manufacturer identifier, a vender identifier, and/or any other PD identifier that would be apparent to one of skill in the art in possession of the present disclosure), and may provide the PD identifier to the PSE device 202 when, for example, a request for the PD identifier is received from the PSE device 202. In a specific example, the first powered device 204a may include the modulator 414 (which may include a demodulator), and the PD identifier may be hardwired or otherwise stored as part of modulation codes provided by the modulator 414. At block 510, the PSE device 202 may provide a probing signal to the port (through which the first powered device 204a is coupled) at a power level that is less than the power level that the PSE device 202 provides to the port when providing operational power to the first powered device 204a (through that port) to power the PD application hardware 404. For example, the PSE device 202 may provide enough power to power up the modulator 414 of the first powered device 204a such that the first powered device 204a can provide the PD identifier to the PSE device 202 through the PHY 410, front-end circuits 408, the port 406, and over the cable 412 to the PSE device 202. In a specific example, the demodulator 320 (which may include a modulator) and/or the powering engine 304 of the PSE device 202 may provide a probing voltage according to any low power modulation technique (e.g., pulse amplitude modulation (PAM), pulse width modulation (PWM), constant amplitude zero autocorrelation (CAZAC), and/or other lower power modulation techniques known in the art), and demodulate any returning signal from the first powered device 204a that includes the PD identifier.

If a PD identifier is not detected at block 510, the method 500 proceeds to block 512 where the PSE device determines whether a timeout period has been satisfied. In an embodiment, the powering engine 304 of the PSE device 202 determines whether the timeout period (e.g., a time threshold, a count of the number of failed attempts to retrieve the PD identifier, and/or other timeout periods that would be apparent to one of skill in the art in possession of the present disclosure) has been satisfied. For example, the authorization period of the power provisioning process may include a timeout period such that, if the first powered device 204a being probed by the PSE device 202 does not have a PD identifier and does not respond to the probe within the timeout period, the PSE device 202 recognizes that the first powered device 204a does not have a PD identifier and continues with the method 500. The timeout period may be an expected time it takes the PSE device 202 to provide a probing signal and receive a response. For example, the time to transmit a probing signal using CAZAC low power modulations may take 0.254 μs. Thus, the timeout period may greater than 0.254 μs. However, the PSE device 202 may be configurable to have other timeout periods while remaining within the scope of the present disclosure. For example, to insure proper reception of the probing signal, the PSE device 202 may be configured to transmit N number of repetitions of the probing signal where N is greater than one. Thus, if N is provided to include 4 repetitions, the timeout period for the authorization period may be 1.024 μs. If the timeout period has not been satisfied at block 512, the method 500 returns to block 510. If the timeout period has been satisfied at block 512, the method 500 proceeds to optional block 514 where a determination is made whether to authorize the powered device, discussed below.

Returning to block 510, if the PSE device determines that the device (which was determined to be a powered device at block 506) includes a PD identifier, then the method 500 proceeds to block 518 where the PSE device determines whether the PD identifier indicates that the powered device is an authorized device. In an embodiment, the powering engine 304 of the PSE device 202 may determine whether the PD identifier indicates that the first powered device 204a is an authorized powered device. For example, the powering engine 304 may compare the PD identifier that was demodulated (i.e., from the signal received by the demodulator 320 from the modulator 414) to a plurality of PD identifiers stored in the PD identifier database 322. Each PD identifier stored in the PD identifier database may be associated with an authorization indicator that indicates to the powering engine 304 whether its associated PD identifier identifies an authorized powered device. In addition, PD identifiers may be associated with authorization indicators that indicate to the powering engine 304 if a PD identifier identifies an unauthorized powered device, or a lack of a PD identifier/authorization indicator may indicate to the powering engine 304 that a PD identifier has been received from an unauthorized device. In a specific example, if the powering engine 304 determines that that received PD identifier matches one of the PD identifiers stored in the PD identifier database, then the powering engine may determine, based on the authorization indicator associated with the stored PD identifier, whether the first powered device 204a is an authorized powered device or an unauthorized powered device. However, as discussed above, the PD identifier database may be configured such that a lack of a match between the received PD identifier and any stored PD identifiers in the PD identifier database 322 may indicate that the PD is an unauthorized powered device. However, in other configurations, the lack of a match between the received PD identifier and the stored PD identifiers may indicate that the first powered device 204a is an authorized powered device.

If, at block 518, the PSE device determines that the powered device is an unauthorized device, the method 500 may proceed to block 514 where a determination is made whether to authorize the powered device. In an embodiment, block 514 may provide a configuration period where the PSE device 202 may determine to configure the first powered device 204a as an authorized powered device (i..e, if the first powered device 204a does not include a PD identifier or is otherwise an unauthorized powered device as discussed above with respect to blocks 512 and 518, respectively.) For example, the PSE device 202 may provide a notification to an administrator that an unauthorized powered device has been connected to the PSE device 202. The notification may be provided as a graphical display, an email, a text message, via a software application, as a sound file that is executable by a system to produce a sound, etc.

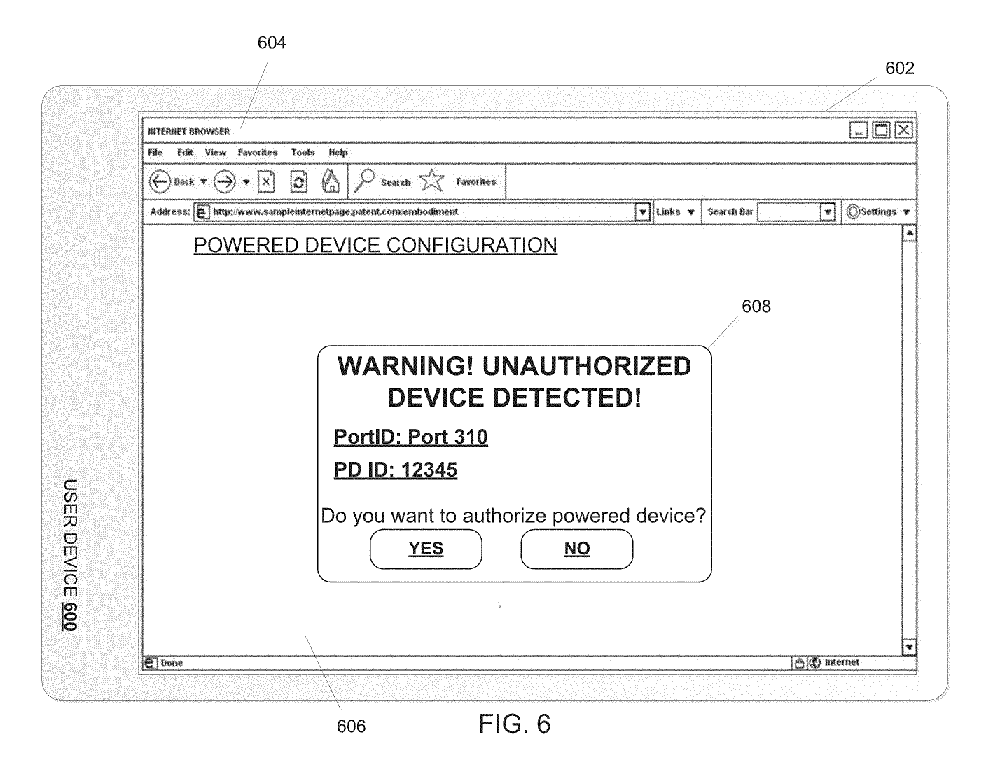

Referring to FIG. 6, a screenshot of a specific example of a graphical user interface, which may be provided as part of the notification that an unauthorized powered device is coupled to the PSE device, is illustrated with reference to block 518 of method 500 of FIG. 5. An unauthorized powered device configuration user interface 606 may be displayed on a display screen 602 of a user device 600 that may be coupled to the PSE device 202/300, with the display screen 602 provided as part of the display system 324. As illustrated, the user device 600 is a device that is separate and distinct from the PSE device 202/300, and may be provided by the IHS discussed above with reference to FIG. 1 and/or may include some or all of the components of the IHS 100. In specific embodiments, the user device 600 may be provided by a computing device (e.g., desktop computing device(s), laptop/notebook computing device(s), tablet computing device(s), mobile phone(s), etc.) known in the art. As illustrated, the powered device configuration user interface 606 provided by the unauthorized powered device configuration application 305 may be displayed through a browser application 604 that may be used to access the powered device configuration application through a network (e.g., Internet) coupled to the communication system 306. However, one of skill in the art in possession of the present disclosure will recognize that the powered device configuration application 305 may be provided as a native application on the user device 600 (e.g., when the user device 600 and the PSE device 300 are provided by the same device.)

As illustrated by the screenshot of FIG. 6, the unauthorized powered device configuration user interface 606 may provide a notification 608 that the PSE device 202 has detected that the first powered device 202a is an unauthorized powered device. The notification 608 may provide any information that can be derived from the PD identifier received from the first powered device 204a. For example, the notification 608 may provide a port identifier of the port (e.g., the port 310) on the PSE device 202 that is coupled to the first powered device 204a, the PD identifier, any vendor information that may be derived from the PD identifier, and other information available to the PSE device 202 about the first powered device 204a after the authorization period performed during the power provisioning process. The notification 608 may also include an option to configure the first powered device 204a as an authorized powered device. As illustrated, a user may select an option to either authorize the first powered device 204a or leave the first powered device 204a as an unauthorized powered device. Authorizing the first powered device 204a as an authorized powered device may cause the powered device configuration application 305 to add an entry to the PD identifier database 322 that includes an association between the PD identifier retrieved from the first powered device 204a and an authorized powered device indicator. In response to the selection of an option to leave the first powered device 204a unauthorized, the powered device configuration application 305 may do nothing, and/or may cause the powering engine 304 to proceed to block 516 of method 500 (i.e., because the first powered device 204a was configured as an unauthorized device.) In another example, leaving the first powered device 204a as an unauthorized powered device may cause the powered device configuration application 305 to add an entry to the PD identifier database 322 that includes an association between the PD identifier of the first powered device 204a and an unauthorized powered device indicator. In various embodiments, the administrator may access the PD identifier database 322 through the powered device configuration application 305 in order to, for example, change any of the authorization indicators associated with the PD identifiers stored in the PD identifier database from an authorized state to an unauthorized state or from an unauthorized state to an authorized state.

If the powered device is determined to be unauthorized at block 514, then the method 500 may proceed to block 516 where the OSE device may prevent power through the interface of the PSE device that is coupled to the interface of the powered device that is unauthorized. In an embodiment, the PSE device 202 may prevent power from being provided to the interface 208 that is coupled to the first powered device 204a. For example, the powering engine 304 may prevent power from being provided to the port 310 that may be coupled to the first powered device 204a. The method 500 may end following block 516.

Returning to block 514 and block 518, if the powered device is determined to be an authorized power device, then the method 500 may proceed to block 520 where the PSE device may continue with the next period of the power provisioning process. For example, the PSE device may proceed to a classification period of the power provisioning process. The classification period may be an optional power provisioning process period according to IEEE 802.3af standards or IEEE 802.3at standards. During the classification period, the PSE device 202 may provide power (e.g., 15.5-20.5 Vdc, limited to 100 mA) for a period of 10 to 75 ms. The classification circuit 418 of the first powered device 204a may then respond to the provisioned voltage by drawing a current from the PSE device 202 over the cable 412, and the PSE device 202 may measure the current draw and, based on the current draw, classify the first powered device 204a. The classification of the first powered device 204a will determine how much power will be provided by the PSE device 202 to the first powered device 204a. For example, there are currently five classifications in most conventional PoE systems: class 0, the default classification, includes powered devices that draw a current of 0-4 mA and the PSE device 202 provides a power range of 0.44-12.94 W to powered devices in this class; class 1 includes powered devices that draw a current of 9-12 mA and the PSE device 202 provides a power range of 0.44-3.84 W to powered devices in this class; class 2 includes powered devices that draw a current of 17-20 mA and the PSE device 202 provides a power range of 3.84-6.49 W to powered devices in this class; class 3 includes powered devices that draw a current of 26-30 mA and the PSE device 202 provides a power range of 6.49-12.95 W to powered devices in this class; and class 4, used by 802at devices, includes powered devices that draw a current of 36-44 mA and the PSE device 202 provides a power range of 12.95-25.5 W to powered devices in this class.

After the optional classification period has completed, the PSE device 202 may switch from providing low voltage to the first powered device 204a to providing an operational voltage (e.g., 44-57 V) over the PSE device port coupled to the first powered device 204a, which causes the PD application hardware to be powered sufficiently to operate the first powered device 204a at its full (or substantially full) functionality. The PSE device 202 may provide to the first powered device 204a a power level based on the classification of the PSE device 202 that results in the PD application hardware 404 to be powered and operational. In an embodiment, full or substantially full functionality of a powered device may include a variety of functionality that enables at least the basic features of the powered device (e.g., wireless access point features for access points, video recording features for cameras, calling features for phones, and/or features other than the simple PD signature and PD identifier functionality discussed above.) As such, while complete full functionality of the powered device may not be enabled following the classification period (e.g., when power to the PSE device is limited), a higher level of functionality will be provided relative to the minimal functionality that allows the powered device to share its signature and identifier information with the PSE device to enable the method 500.

Thus, systems and methods have been described that provide for efficient, secure, and configurable power distribution in a PoE system. A PSE device may perform an authorization process after determining a device, which is coupled to the PSE device through an interface that may provide both data and power to the device, is a powered device. If the PSE device determines that the powered device is not an authorized powered device, the PSE device may prevent operational power from being provided through the interface to the connected device. As such, power is not wasted by providing it to unauthorized devices that are connected to the PSE device, as minimal power is used to determine whether that device is authorized and power is then cut off from that device if it is not authorized. In addition, the PSE device may be configurable to allow an administrator of the PSE device may configure otherwise unauthorized powered devices to be authorized powered devices. As such, the systems and methods of the present disclosure provide for a more secure and efficient power distribution system that makes a determination as to whether the powered device is unauthorized or authorized before that powered device receives operational power.

Although illustrative embodiments have been shown and described, a wide range of modification, change and substitution is contemplated in the foregoing disclosure and in some instances, some features of the embodiments may be employed without a corresponding use of other features. Accordingly, it is appropriate that the appended claims be construed broadly and in a manner consistent with the scope of the embodiments disclosed herein.

What is claimed is:

1. A power over Ethernet (PoE) system, comprising:
a device; and
a power sourcing equipment (PSE) device that is configured to couple to the device through an Ethernet cable, wherein the PSE device is configured to:
detect, in response to the device being coupled to the PSE device, that the device is a powered device;
determine, subsequent to detecting that the device is a powered device, whether a powered device identifier has been received from the device;
determine, in response to determining that a powered device identifier was received from the device, that the powered device identifier identifies an authorized powered device;
identify, in response to determining that the powered device identifier identifies is an authorized powered device, a powered device classification of the powered device; and
provide, to the device via the Ethernet cable, first power according to the powered device classification.

2. The PoE system of claim 1, wherein the PSE device is configured to:
determine that a powered device identifier has not been received from the device and, in response, prevent power from being provided to the device via the Ethernet cable.

3. The PoE system of claim 1, wherein the PSE device is configured to:
provide, via the Ethernet cable, second power to the powered device that is less than the first power; and
receive, via the Ethernet cable, the powered device identifier from the device that is operating using the second power.

4. The PoE system of claim 3, wherein the second power is sufficient to power only a storage subsystem in the powered device that stores the powered device identifier, and a data transmission subsystem in the powered device that transmits the powered device identifier from the storage subsystem to the PSE device.

5. The PoE system of claim 1, wherein the powered device identifier includes at least one of a device serial number, a product identifier, a product manufacturer identifier, and a vender identifier.

6. The PoE system of claim 1, wherein the PSE device is configured to:
determine that a powered device identifier has not been received from the device and, in response, provide an unauthorized device notification for display on a display device that is coupled to the PSE device.

7. The PoE system of claim 6, wherein the PSE device is configured to:
receive, subsequent to the providing the unauthorized device notification for display, an instruction to provide power to the device and, in response, identify the powered device classification of the powered device and provide the first power to the device via the Ethernet cable and according to the powered device classification.

8. A power sourcing equipment (PSE) device, comprising:
a power over Ethernet (PoE) interface;
a processing system coupled to the PoE interface; and
a memory system coupled to the processing system and including instructions that, when executed by the processing system, cause the processing system to:
detect, in response to a device being coupled to the PSE device through the PoE interface, that the device is a powered device;
determine, subsequent to detecting that the device is a powered device, whether a powered device identifier has been received from the device;
determine, in response to determining that a powered device identifier was received from the device, that the powered device identifier identifies an authorized powered device;
identify, in response to determining that the powered device identifier identifies is an authorized powered device, a powered device classification of the powered device; and
provide, to the device via the PoE interface, first power according to the powered device classification.

9. The PSE device of claim 8, wherein the memory system includes instructions that, when executed by the processing system, cause the processing system to:
determine that a powered device identifier has not been received from the device and, in response, prevent power from being provided to the device via the PoE interface.

10. The PSE device of claim 8, wherein the memory system includes instructions that, when executed by the processing system, cause the processing system to:
provide, via the PoE interface, second power to the powered device that is less than the first power; and
receive, via the PoE interface, the powered device identifier from the device that is operating using the second power.

11. The PSE device of claim 10, wherein the second power is sufficient to power only a storage subsystem in the powered device that stores the powered device identifier, and a data transmission subsystem in the powered device that transmits the powered device identifier from the storage subsystem to the PSE device.

12. The PSE device of claim 8, wherein the powered device identifier includes at least one of a device serial number, a product identifier, a product manufacturer identifier, and a vender identifier.

13. The PSE device of claim 8, wherein the memory system includes instructions that, when executed by the processing system, cause the processing system to:
determine that a powered device identifier has not been received from the device and, in response, provide an unauthorized device notification for display on a display device that is coupled to the PSE device.

14. The PSE device of claim 13, wherein the memory system includes instructions that, when executed by the processing system, cause the processing system to:
receive, subsequent to the providing the unauthorized device notification for display, an instruction to provide power to the device and, in response, identify the powered device classification of the powered device and provide the first power to the device via the PoE interface and according to the powered device classification.

15. A method for providing power, comprising:
detecting, by a power sourcing equipment (PSE) device in response to a device being coupled to the PSE device through a power over Ethernet (PoE) interface, that the device is a powered device;
determining, by the PSE device subsequent to detecting that the device is a powered device, whether a powered device identifier has been received from the device;
determining, by the PSE device in response to determining that a powered device identifier was received from the device, that the powered device identifier identifies an authorized powered device;
identifying, by the PSE device in response to determining that the powered device identifier identifies is an authorized powered device, a powered device classification of the powered device; and
providing, by the PSE device to the device via the PoE interface, first power according to the powered device classification.

16. The method of claim 15, further comprising:
determining, by the PSE device, that a powered device identifier has not been received from the device and, in response, prevent power from being provided to the device via the PoE interface.

17. The method of claim 15, further comprising:
providing, by the PSE device via the PoE interface, second power to the powered device that is less than the first power; and
receiving, by the PSE device via the PoE interface, the powered device identifier from the device that is operating using the second power.

18. The method of claim 17, wherein the second power is sufficient to power only a storage subsystem in the powered device that stores the powered device identifier, and a data transmission subsystem in the powered device that transmits the powered device identifier from the storage subsystem to the PSE device.

19. The method of claim 15, wherein the powered device identifier includes at least one of a device serial number, a product identifier, a product manufacturer identifier, and a vender identifier.

20. The method of claim 15, further comprising:
determining, by the PSE device, that a powered device identifier has not been received from the device and, in response, provide an unauthorized device notification for display on a display device that is coupled to the PSE device.
